(19) United States
(12) Patent Application Publication
(10) Pub. No.: US 2004/0021797 A1
(43) Pub. Date: Feb. 5, 2004

(54) Receiver

(76) Inventors: Masami Onoue, Tokyo (JP); Yukinori Hidaka, Saitama (JP); Kosuke Fujita, Kanagawa (JP)

Correspondence Address: William S Frommer, Frommer Lawrence & Haug, 745 Fifth Avenue, New York, NY, 10151, US

(21) Appl. No.: 10/296,757

(22) PCT Filed: Jan. 16, 2002
(86) PCT No.: PCT/JP02/00232

(30) Foreign Application Priority Data
Jan. 16, 2001 (JP) 2001-7485

(51) Int. Cl. H04N 5/44

(52) U.S. Cl. 348/725

(57) ABSTRACT

The present invention relates to a receiver capable of carrying out waveform detection without utilizing a SAW filter.

A multiplier 22 multiplies together sin ω₀t supplied from a local oscillator 26 and a broadcast signal V_{VSB}. A multiplier 24 multiplies, by the broadcast signal V_{VSB}, cos ω₀t that the sin ω₀t supplied from a shift section 27 is shifted in phase by π/2. A processing section 28 converts ω₀ to ω_{c} on a signal supplied from the multiplier 24 through an LPF 25 and on a signal supplied from the multiplier 22 through an LPF 23, and outputs a resultingly obtained signal to a shift section 29 and an adder 30. The shift section 29 shifts the phase of a signal obtained from the processing section 28 by π/2, and outputs it to the adder 30. The adder 30 adds together a signal from the shift section 29 and a signal from the processing section 28. In this manner, a base band signal is detected.

### TECHNICAL FIELD

The present invention relates to receivers and, more particularly, to a receiver to be suitably applied to a case to detect an analog television broadcast signal.

### BACKGROUND OF THE INVENTION

In the receiving section of a television broadcast signal receiver, an objective broadcast wave is converted into a predetermined intermediate frequency. The converted intermediate frequency is demodulated into base-band video and audio signals.

FIG. 1 shows a configuration example of a receiving section of a conventional television broadcast signal receiver. Note that FIG. 1 shows only a configuring section to demodulate video signals, for simplicity sake.

The television broadcast signal received at an antenna 1 is inputted to a front end 2. Incidentally, the television broadcast signal in this case is an analog broadcast signal V_{VSB} (hereinafter, abbreviated as a broadcast signal V_{VSB}) in a VSB (Vestigial Side Band).

The front end 2 generates an intermediate frequency signal from an inputted broadcast signal V_{VSB} and outputs it to a SAW filter 3.

The SAW filter 3 carries out a Nyquist slope process on the intermediate frequency signal from the front end 2 to remove sideband and out-of-band components and forwards a resultingly obtained base band signal having a flat characteristic through a waveform detecting section 4.

The waveform detecting section 4 waveform-detects an intermediate frequency signal (video modulated signal) in an output of the SAW filter 3 on the basis of a synchronizing signal obtained by an incorporated PLL circuit, and outputs a resultingly obtained video signal to an external apparatus via a low-pass filter 5.

Next, the operation of the receiving section is explained.

The usual AM-modulated signal V_{AM} (amplitude-modulated signal) is to be expressed by Equation (1).

$${V}_{AM} = ( {V}_{c} + {V}_{m} sin {ω}_{m} t ) sin {ω}_{c} t \\ = {V}_{c} sin {ω}_{c} t + ( \frac{m {V}_{c}}{2} ) cos ( {ω}_{c} - {ω}_{m} ) t - ( \frac{m {V}_{c}}{2} ) cos ( {ω}_{c} - {ω}_{m} ) t \qquad ( 1 )$$

In Equation (1), V_{c} represents a modulated-signal direct current component, Vₘ sin ωₘt a modulated-signal alternating current component and sin ω_{c}t a carrier. ωₘ represents a modulated-signal angular frequency, Vₘ an amplitude of a modulated signal containing modulation and ω_{c} a carrier angular frequency.

In Equation (1), the modulated-signal alternating current component was given as a singular sinusoidal wave sin ωₘt. However, the actual broadcast wave can be expressed more properly by providing a modulated signal as a distorted-wave alternating current (Fourier series) shown in Equation (2). Equation (3) represents an AM-modulated signal V_{AM} where the modulated signal is given as a distorted-wave alternating current of Equation (2).

$$\begin{matrix}{β}_{0} + {\sum }_{n = 1}^{q} {β}_{n} cos n {ω}_{m} t + {\sum }_{n = 1}^{q} {α}_{n} sin n {ω}_{m} t & ( 2 ) \\ {V}_{AM} = [ {V}_{c} + {V}_{m} \times ( {β}_{0} + {\sum }_{n = 1}^{q} {β}_{n} cos n {ω}_{m} t + {\sum }_{n = 1}^{q} {α}_{n} sin n {ω}_{m} t ) ] \times sin {ω}_{c} t \\ = [ {V}_{c}^{′} {V}_{m} {\sum }_{n = 1}^{q} ( {β}_{n} cos n {ω}_{m} t + {α}_{n} sin n {ω}_{m} t ) ] \times sin {ω}_{c} t \\ = [ {V}_{c}^{′} {V}_{m} {\sum }_{n = 1}^{q} ( \sqrt{{α}_{n}^{2} + {β}_{n}^{2}} sin ( n {ω}_{m} t + {ψ}_{n} ) ) ] \times sin {ω}_{c} t \\ = [ {V}_{c}^{′} {V}_{m} {\sum }_{n = 1}^{q} ( {γ}_{n} sin ( n {ω}_{m} t + {ψ}_{n} ) ) ] \times sin {ω}_{c} t & ( 3 )\end{matrix}$$

Incidentally, in Equation (2), q represents an upper limit of a video signal band. Meanwhile, V′_{c} (=V_{c}+Vₘ×β₀) in Equation (3) represents a direct current component. ψₙ and γₙ are to be expressed as in Equation (4).

$${ψ}_{n} = {tan}^{- 1} \frac{{β}_{n}}{{α}_{n}} \\ {γ}_{n} = \sqrt{{α}_{n}^{2} + {β}_{n}^{2}} \qquad ( 4 )$$

Furthermore, Equation (3) can be expanded as in Equation (5), due to its triangular function nature. Namely, Equation (5) represents an AM-modulated signal V_{AM} of a distorted-wave alternating current DSB (Double side band)-expanded.

$${V}_{AM} = [ {V}_{c}^{′} + {V}_{m} {\sum }_{n = 1}^{q} ( {γ}_{n} sin ( n {ω}_{m} t + {ψ}_{n} ) ) ] \times sin {ω}_{c} t \\ = [ {V}_{c}^{′} sin {ω}_{c} t + \frac{{V}_{m}}{2} {\sum }_{n = 1}^{q} [ {γ}_{n} cos ( {ω}_{c} t - n {ω}_{m} t - {ψ}_{n} ) ] - \frac{{V}_{m}}{2} {\sum }_{n = 1}^{q} [ {γ}_{n} cos ( {ω}_{c} t + n {ω}_{m} t + {ψ}_{n} ) ] \qquad ( 5 )$$

Also, by removing the p-th (1<p<q) and subsequent in the second term LSB (Lower Side Band) of Equation (5), obtained is a VSB (Vestigial Side Band) broadcast signal V_{VSB} shown in Equation (6).

$${V}_{VSB} = {V}_{c}^{′} sin {ω}_{c} t + \frac{{V}_{m}}{2} {\sum }_{n = 1}^{p} [ {γ}_{n} cos ( {ω}_{c} t - n {ω}_{m} t - {ψ}_{n} ) ] - \\ \frac{{V}_{m}}{2} {\sum }_{n = 1}^{p} [ {γ}_{n} cos ( {ω}_{c} t + n {ω}_{m} t + {ψ}_{n} ) ] - \\ \frac{{V}_{m}}{2} {\sum }_{n = p + 1}^{q} [ {γ}_{n} cos ( {ω}_{c} t + n {ω}_{m} t + {ψ}_{n} ) ] \qquad ( 6 )$$

Namely, the broadcast signal V_{VSB} expressed by Equation (6) is received at the antenna 1 (FIG. 1) and supplied to the front end 2.

The front end 2 has a configuration including a multiplier 11 and a local oscillator 12. Incidentally, besides the multiplier 11 and the local oscillator 12, the front end 2 is provided with an amplifier for RF signal amplification, an output tuner for extracting an objective intermediate frequency signal out of an output of the multiplier 11, and the like, which are omittedly shown and explained.

The broadcast signal V_{VSB} supplied to the front end 2 is inputted to the multiplier 11. The multiplier 11 multiplies together a local signal, expressed by Equation (7), supplied from the local oscillator 12 and the broadcast signal V_{VSB} (signal expressed by Equation (6)), to generate an intermediate frequency signal expressed by Equation (8).

sin(ω₀+ω_{IF}) (7)

$${V}_{VSB} \times sin ( {ω}_{0} + {ω}_{IF} ) t = {V}_{c}^{′} sin {ω}_{c} t + sin ( {ω}_{0} + {ω}_{IF} ) t + \\ \frac{{V}_{m}}{2} {\sum }_{n = 1}^{p} {γ}_{n} [ cos ( {ω}_{c} t - n {ω}_{m} t - {ψ}_{n} ) \times sin ( {ω}_{0} + {ω}_{IF} ) t ] - \\ \frac{{V}_{m}}{2} {\sum }_{n = 1}^{p} {γ}_{n} [ cos ( {ω}_{o} t + n {ω}_{m} t + {ψ}_{n} ) \times sin ( {ω}_{0} + {ω}_{IF} ) t ] - \\ \frac{{V}_{m}}{2} {\sum }_{n = p + 1}^{q} {γ}_{n} [ cos ( {ω}_{c} t + n {ω}_{m} t + {ψ}_{n} ) \times sin ( {ω}_{0} + {ω}_{IF} ) t ] \qquad ( 8 )$$

Equation (8) can be expanded as shown in Equations (9) to (11). Namely, according to the finally expanded Equation (11), in the equation the Σ-term values (second value, third value and fourth value) are negative values. Accordingly, in the case the waveform of the broadcast signal V_{VSB} is represented simulatively as shown in FIG. 2A, generated is such an intermediate frequency signal as an inversion of the broadcast signal V_{VSB} with reference to a reference frequency (carrier frequency) of an RF signal as shown in FIG. 2B.

$${V}_{VSB} \times sin ( {ω}_{0} + {ω}_{IF} ) = - \frac{{V}_{c}^{′}}{2} \{ cos ( {ω}_{c} t + {ω}_{0} t + {ω}_{IF} t ) - cos ( {ω}_{c} t - {ω}_{0} t - {ω}_{IF} t ) \} + \\ \frac{{V}_{m}}{2} {\sum }_{n = 1}^{p} \frac{{γ}_{n}}{2} \{ sin ( {ω}_{c} t - n {ω}_{m} t - {ψ}_{n} + {ω}_{0} t + {ω}_{IF} t ) - sin ( {ω}_{c} t - n {ω}_{m} t - {ψ}_{n} - {ω}_{0} t - {ω}_{IF} t ) \} - \\ \frac{{V}_{m}}{2} {\sum }_{n = 1}^{p} \frac{{γ}_{n}}{2} \{ sin ( {ω}_{c} t + n {ω}_{m} t + {ψ}_{n} + {ω}_{0} t + {ω}_{IF} t ) - sin ( {ω}_{c} t + n {ω}_{m} t + {ψ}_{n} - {ω}_{0} t - {ω}_{IF} t ) \} - \\ \frac{{V}_{m}}{2} {\sum }_{n = p + 1}^{q} \frac{{γ}_{n}}{2} \{ sin ( {ω}_{c} t + n {ω}_{m} t + {ψ}_{n} + {ω}_{0} t + {ω}_{IF} t ) - sin ( {ω}_{c} t + n {ω}_{m} t + {ψ}_{n} - {ω}_{0} t - {ω}_{IF} t ) \} \qquad ( 9 )$$

$$\begin{matrix}{V}_{VSB} + sin ( {ω}_{0} + {ω}_{IF} ) = \frac{{V}_{c}^{′}}{2} cos {ω}_{IF} t + \frac{{V}_{m}}{2} {\sum }_{n = 1}^{p} \frac{{γ}_{n}}{2} [ sin ( {ω}_{IF} t + n {ω}_{m} t + {ψ}_{n} ) ] - \frac{{V}_{m}}{2} {\sum }_{n = 1}^{p} \frac{{γ}_{n}}{2} [ sin ( {ω}_{IF} t - n {ω}_{m} t - {ψ}_{n} ) ] - \frac{{V}_{m}}{2} {\sum }_{n = p + 1}^{q} \frac{{γ}_{n}}{2} [ sin ( {ω}_{IF} t - n {ω}_{m} t - {ψ}_{n} ) ] & ( 10 ) \\ {V}_{VSB} + sin ( {ω}_{0} + {ω}_{IF} ) = \frac{{V}_{c}^{′}}{2} cos {ω}_{IF} t + \frac{{V}_{m}}{4} {\sum }_{n = 1}^{p} [ {γ}_{n} sin ( {ω}_{IF} t + n {ω}_{m} t + {ψ}_{n} ) ] - \frac{{V}_{m}}{4} {\sum }_{n = 1}^{p} [ {γ}_{n} sin ( {ω}_{IF} t - n {ω}_{m} t - {ψ}_{n} ) ] - \frac{{V}_{m}}{4} {\sum }_{n = p + 1}^{q} [ {γ}_{n} sin ( {ω}_{IF} t - n {ω}_{m} t - {ψ}_{n} ) ] & ( 11 )\end{matrix}$$

The front end 2 (multiplier 11) outputs a generated intermediate frequency signal (Equation (11)) to the SAW filter 3.

The SAW filter 3 carries out a Nyquist slope process on the intermediate frequency signal (signal expressed by Equation (11)) supplied from the front end 2 to remove a side-band component and forwards, at the detecting section 4, a resultingly obtained base-band signal having a flat characteristic.

In case the waveform of an intermediate frequency signal from the front end 2 is shown in FIG. 2B, the waveform of an intermediate frequency signal from the front end 2 is in a waveform removed of a high-frequency component as shown in FIG. 2C due to a Nyquist slope process in the SAW filter 3.

The detecting section 4 detects the intermediate frequency signal supplied from the SAW filter 3, on the basis of a synchronizing signal obtained by an incorporated PLL circuit and outputs a resultingly obtained video signal (FIG. 2D) to an external apparatus through a low-pass filter 5.

In this manner, in the conventional television broadcast signal receiver, an intermediate frequency signal is subjected to a Nyquist slope process by the SAW filter 3 thereby detecting a video signal. However, because the SAW filter 3 is comparatively expensive, there has been a problem that the apparatus is high in cost. Also, there has been a problem that the characteristic variation possessed by the SAW filter 3 has an effect upon detection performances and further what is called Nyquist slope buzz occurs.

Meanwhile, in the conventional apparatus, because of utilizing an intermediate frequency, there has been a problem that the affection of interference waves relying upon the intermediate frequency is problematic.

### DISCLOSURE OF THE INVENTION

The present invention has been made in view of such a circumstance, which aims at carrying out detection without the utilization of a SAW filter.

A receiver of the invention comprises: first generating means for multiplying an analog television broadcast signal by a first reference signal to generate a first signal to be detected; second generating means for multiplying the analog television broadcast signal by a second reference signal orthogonal to the first reference signal to generate a second signal to be detected; and detecting means for detecting a base band signal, on the basis of the first signal to be detected and the second signal to be detected.

It is possible to further provide third generating means to generate an intermediate frequency signal from the analog television broadcast signal, so that the first generating means can multiply the intermediate frequency signal by the first reference signal to generate the first signal to be detected while the second generating means can multiply the intermediate frequency signal by the second reference signal to generate the second signal to be detected.

It is possible to further provide removing means to remove an unwanted high-frequency component contained in an intermediate frequency signal, so that the first generating means can multiply the first reference signal on the intermediate frequency signal removed of an unwanted high-frequency component by the removing means to generate the first signal to be detected while the second generating means can multiply the second reference signal on the intermediate frequency signal removed of an unwanted high-frequency component by the removing means to generate the second signal to be detected.

A method of receiving a signal comprises: a first generating step of multiplying an analog television broadcast signal by a first reference signal to generate a first signal to be detected; a second generating step of multiplying the analog television broadcast signal by a second reference signal orthogonal to the first reference signal to generate a second signal to be detected; and a detecting step of detecting a base band signal, on the basis of the first signal to be detected and the second signal to be detected.

A program on a recording medium of the invention comprises: a first generating step of multiplying an analog television broadcast signal by a first reference signal to generate a first signal to be detected; a second generating step of multiplying the analog television broadcast signal by a second reference signal orthogonal to the first reference signal to generate a second signal to be detected; and a detecting step of detecting a base band signal, on the basis of the first signal to be detected and the second signal to be detected.

A program of the invention comprises: a first generating step of multiplying an analog television broadcast signal by a first reference signal to generate a first signal to be detected; a second generating step of multiplying the analog television broadcast signal by a second reference signal orthogonal to the first reference signal to generate a second signal to be detected; and a detecting step of detecting a base band signal, on the basis of the first signal to be detected and the second signal to be detected.

In the receiver, receiving method and program of the invention, an analog television broadcast signal is multiplied by a first reference signal to generate a first signal to be detected while the analog television broadcast signal is multiplied by a second reference signal orthogonal to the first reference signal to generate a second signal to be detected. A base band signal is detected on the basis of the first signal to be detected and the second signal to be detected.

### BRIEF DESCRIPTION OF THE DRAWINGS

FIG. 1 is a block diagram showing a configuration example of a receiving section of a conventional television broadcast signal receiver.

FIG. 2A is a diagram representing a frequency characteristic.

FIG. 2B is another diagram representing a frequency characteristic.

FIG. 2C is another diagram representing a frequency characteristic.

FIG. 2D is another diagram representing a frequency characteristic.

FIG. 3 is a block diagram showing a configuration example of a receiving section of a television broadcast signal receiver to which the present invention is applied.

FIG. 4A is another diagram representing a frequency characteristic.

FIG. 4B is another diagram representing a frequency characteristic.

FIG. 4C is another diagram representing a frequency characteristic.

FIG. 4D is another diagram representing a frequency characteristic.

FIG. 5 is a block diagram showing a configuration example of another receiving section of a television broadcast signal receiver to which the present invention is applied.

FIG. 6 is a block diagram showing a configuration example of another receiving section of a television broadcast signal receiver to which the present invention is applied.

FIG. 7 is a block diagram showing a configuration example of a computer 101.

### BEST MODE FOR CARRYING OUT THE INVENTION

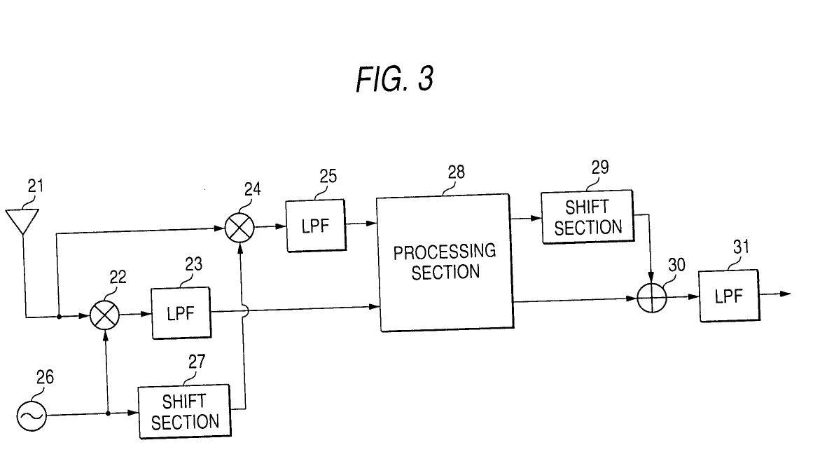

FIG. 3 shows a configuration example of a receiving section of a television broadcast signal receiver to which the present invention is applied.

The broadcast signal V_{VSB} received by an antenna 21 (signal expressed by Equation (6)) is supplied to a multiplier 22 and a multiplier 24, respectively.

The multiplier 22 multiplies together a reference signal sin ω₀t supplied from a local oscillator 26 and the broadcast signal V_{VSB}, and outputs a resultingly obtained signal expressed by Equation (12) to an LPF 23.

$${V}_{VSB} \times sin {ω}_{0} t = {V}_{c}^{′} sin {ω}_{c} t \times sin {ω}_{c} t + \frac{{V}_{m}}{2} {\sum }_{n = 1}^{p} [ {γ}_{n} cos ( {ω}_{c} t - n {ω}_{m} t - {ψ}_{n} ) \times sin {ω}_{o} t ] - \frac{{V}_{m}}{2} {\sum }_{n = 1}^{p} [ {γ}_{n} cos ( {ω}_{c} t + n {ω}_{m} t + {ψ}_{n} ) \times sin {ω}_{o} t ] - \frac{{V}_{m}}{2} {\sum }_{n = p + 1}^{q} [ {γ}_{n} cos ( {ω}_{c} t + n {ω}_{m} t + {ψ}_{n} ) \times sin {ω}_{o} t ] \qquad ( 12 )$$

The LPF 23 removes a high-range component from the signal supplied from the multiplier 22 and outputs a resultingly obtained signal expressed by Equation (13) to a processing section 28.

$$\frac{{V}_{c}^{′}}{2} cos ( {ω}_{c} - {ω}_{0} ) t - \frac{{V}_{m}}{4} {\sum }_{n = 1}^{p} [ {γ}_{n} sin ( {ω}_{c} t - n {ω}_{m} t - {ψ}_{n} - {ω}_{0} t ) ] + \frac{{V}_{m}}{4} {\sum }_{n = 1}^{p} [ {γ}_{n} sin ( {ω}_{c} t + n {ω}_{m} t + {ψ}_{n} - {ω}_{0} t ) ] + \frac{{V}_{m}}{4} {\sum }_{n = p + 1}^{q} [ {γ}_{n} sin ( {ω}_{c} t + n {ω}_{m} t + {ψ}_{n} - {ω}_{0} t ) ] \qquad ( 13 )$$

A shift section 27 shifts, by π/2, the phase of the reference signal sin ω₀t supplied from the local oscillator 26. A multiplier 24 multiplies together a reference signal cos ω₀t supplied from a shift section 27 and the broadcast signal V_{VSB} and supplies a resultingly obtained signal expressed by Equation (14) to an LPF 25.

$${V}_{VSB} \times cos {ω}_{0} t = {V}_{c}^{′} sin {ω}_{c} t \times cos {ω}_{0} t + \frac{{V}_{m}}{2} {\sum }_{n = 1}^{p} [ {γ}_{n} cos ( {ω}_{c} t - n {ω}_{m} t - {ψ}_{n} ) \times cos {ω}_{0} t ] - \frac{{V}_{m}}{2} {\sum }_{n = 1}^{p} [ {γ}_{n} cos ( {ω}_{c} t + n {ω}_{m} t + {ψ}_{n} ) \times cos {ω}_{0} t ] - \frac{{V}_{m}}{2} {\sum }_{n = p + 1}^{q} [ {γ}_{n} cos ( {ω}_{c} t + n {ω}_{m} t + {ψ}_{n} ) \times cos {ω}_{0} t ] \qquad ( 14 )$$

The LPF 25 removes a high-range component from the signal supplied from the multiplier 24 and outputs a resultingly obtained signal expressed by Equation (15), to the processing section 28.

$$\frac{{V}_{c}^{′}}{2} sin ( {ω}_{c} - {ω}_{0} ) t + \frac{{V}_{m}}{4} {\sum }_{n = 1}^{p} [ {γ}_{n} cos ( {ω}_{c} t - n {ω}_{m} t - {ψ}_{n} - {ω}_{0} t ) ] - \frac{{V}_{m}}{4} {\sum }_{n = 1}^{p} [ {γ}_{n} cos ( {ω}_{c} t + n {ω}_{m} t + {ψ}_{n} - {ω}_{0} t ) ] - \frac{{V}_{m}}{4} {\sum }_{n = p + 1}^{q} [ {γ}_{n} cos ( {ω}_{c} t + n {ω}_{m} t + {ψ}_{n} - {ω}_{0} t ) ] \qquad ( 15 )$$

The processing section 28 carries out an operation expressed by Equation (16) on a signal expressed by Equation (13) supplied from the LPF 23, to generates a signal shown by Equation (17) and output it to an adder 30. The processing section 28 also carries out an operation expressed by Equation (16) on a signal expressed by Equation (15) supplied from the LPF 25, to generate a signal expressed by Equation (18) and output it to a shift section 29.

$$\begin{matrix}{Lim}_{{ω}_{0} -> {ω}_{c}} [ {V}_{VSB} \times sin {ω}_{0} t , {V}_{VSB} \times cos {ω}_{0} t ] & ( 16 ) \\ \frac{{V}_{c}^{′}}{2} + \frac{{V}_{m}}{2} {\sum }_{n = 1}^{p} [ {γ}_{n} sin ( n {ω}_{m} t + {ψ}_{n} ) ] + \frac{{V}_{m}}{4} {\sum }_{n = p + 1}^{q} [ {γ}_{n} sin ( n {ω}_{m} t + {ψ}_{n} ) ] & ( 17 ) \\ 0 + \frac{{V}_{m}}{4} {\sum }_{n = 1}^{p} [ {γ}_{n} cos ( n {ω}_{m} t + {ψ}_{n} ) ] - \frac{{V}_{m}}{4} {\sum }_{n = 1}^{p} [ {γ}_{n} cos ( n {ω}_{m} t + {ψ}_{n} ) ] - \frac{{V}_{m}}{4} {\sum }_{n = p + 1}^{q} [ {γ}_{n} cos ( n {ω}_{m} t + {ψ}_{n} ) ] & ( 18 )\end{matrix}$$

The shift section 29 shifts, by π/2 (shifts by 90 degrees), the phase of the signal obtained from the processing section 28, to generate a signal expressed by Equation (19) and output it to the adder 30.

$$- \frac{{V}_{m}}{4} {\sum }_{n = p + 1}^{q} [ {γ}_{n} cos ( n {ω}_{m} t + {ψ}_{n} + \frac{π}{2} ) ] = \frac{{V}_{m}}{4} {\sum }_{n = p + 1}^{q} [ {γ}_{n} sin ( n {ω}_{m} t + {ψ}_{n} ) ] \qquad ( 19 )$$

The adder 30 adds together the signal supplied from the processing section 28 (signal expressed by Equation (17)) and the signal supplied from the shift section 29 (signal expressed by Equation (19)). As a result, obtained is a signal expressed by Equation (20). Equation (20) corresponds to an amplitude component in Equation (3). Namely, this results in a waveform detection of a base band component of the signal expressed by Equation (3). This signal, after removed of an unwanted high-range component by an LPF 31, is outputted to an external apparatus.

$$\frac{1}{2} [ {V}_{c}^{′} + {V}_{m} {\sum }_{n = 1}^{q} [ {γ}_{n} sin ( n {ω}_{m} t + {ψ}_{n} ) ] \} \qquad ( 20 )$$

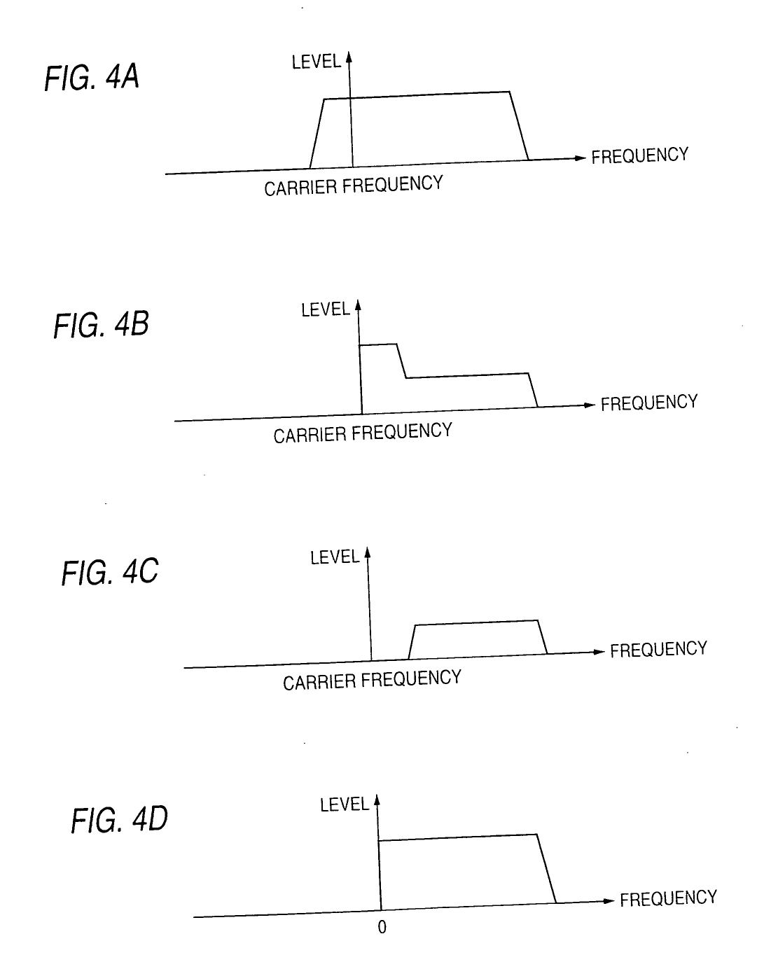

In case a frequency characteristic of the broadcast signal V_{VSB} is represented as shown in FIG. 4A, then the signal supplied from the processing section 28 to the adder 30 is represented as shown in FIG. 4B while the signal supplied from the shift section 29 to the adder 30 is represented as shown in FIG. 4C. By adding together those in the adder 30, generated (detected) is a video signal having a frequency characteristic as shown in FIG. 4D.

Namely, because the receiving section to which the invention is applied is not incorporated with a saw filter, cost can be reduced correspondingly and the receiving section can be simplified in configuration. Also, it is possible to prevent the lowering in the video detection characteristic and voice demodulation characteristic (S/N, S/BUSS) due to an occurrence of Nyquist slope buzz.

Furthermore, because there is no use of an intermediate frequency, the receiving section can be simplified furthermore in configuration, thus eliminating the problem resulting from an interfering wave (various beats) relying upon an intermediate frequency.

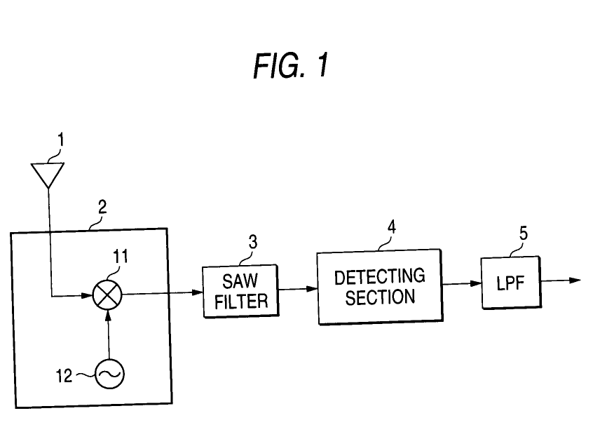

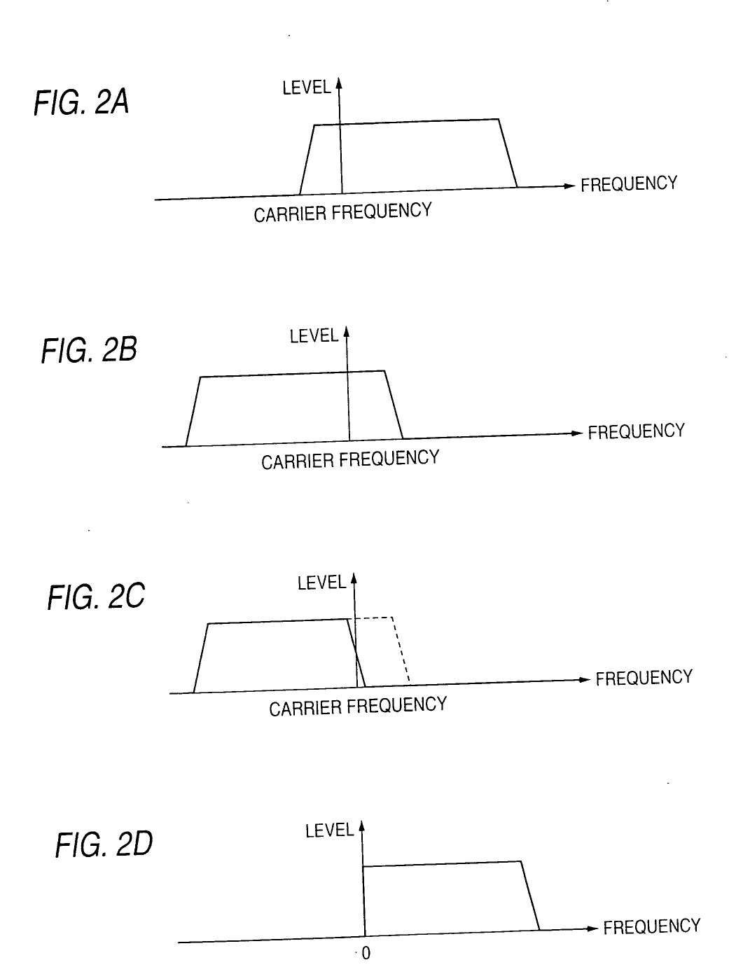

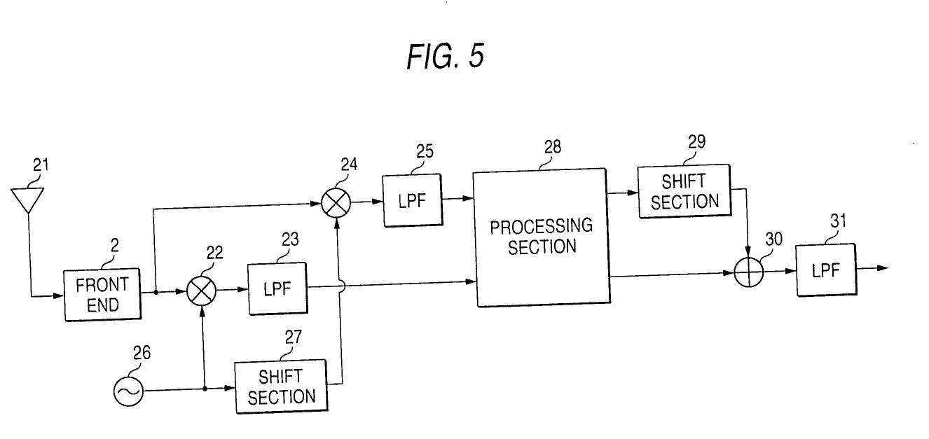

Incidentally, in the above, a base-band signal was detected directly from the RF signal. However, as shown in FIG. 5, the front end 2 shown in FIG. 1 can be provided in the receiving section of FIG. 3 at a front stage of the multiplier 22 (in other words, in place of the SAW filter 3 to LPF 5 the multiplier 22 to LPF 31 shown in FIG. 3 is provided in the receiving section of FIG. 1) to detect a base band signal from an intermediate frequency signal.

Although this example case uses an intermediate frequency, because of no provision of a SAW filter similarly to the case of FIG. 3, cost is correspondingly less and the receiving section can be made simple in configuration.

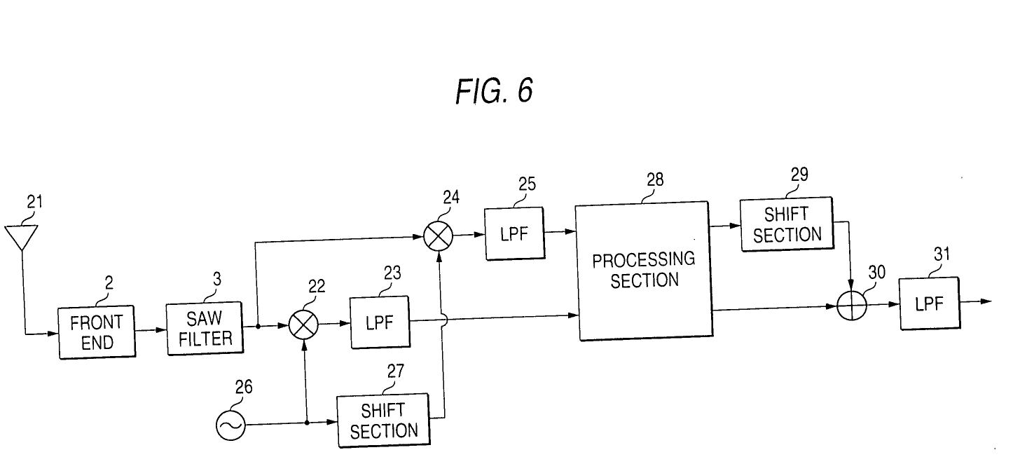

Meanwhile, as shown in FIG. 6, the front end 2 and SAW filter 3 shown in FIG. 1 can be provided in the receiver section of FIG. 3 at a front stage of the multiplier 22 (in other words, in place of the detecting section 4 and LPF 5 the multiplier 22 to LPF 31 shown in FIG. 3 can be provided in the receiving section of FIG. 1).

In this example case, an intermediate frequency is used and a SAW filter 3 is incorporated in the receiving section. However, because there is no need to set a Nyquist slope characteristic onto the SAW filter 3 in this case, the SAW filter 3 is easy to design. Namely, the SAW filter 3 serves to merely remove the unnecessary out-of-band components contained in the intermediate frequency.

The foregoing series of processes, though can be realized on hardware, can be realized on software. In the case of realizing the series of processes on software, the program configuring the software is installed on a computer. By executing the program over the computer, the foregoing detection process can be functionally realized.

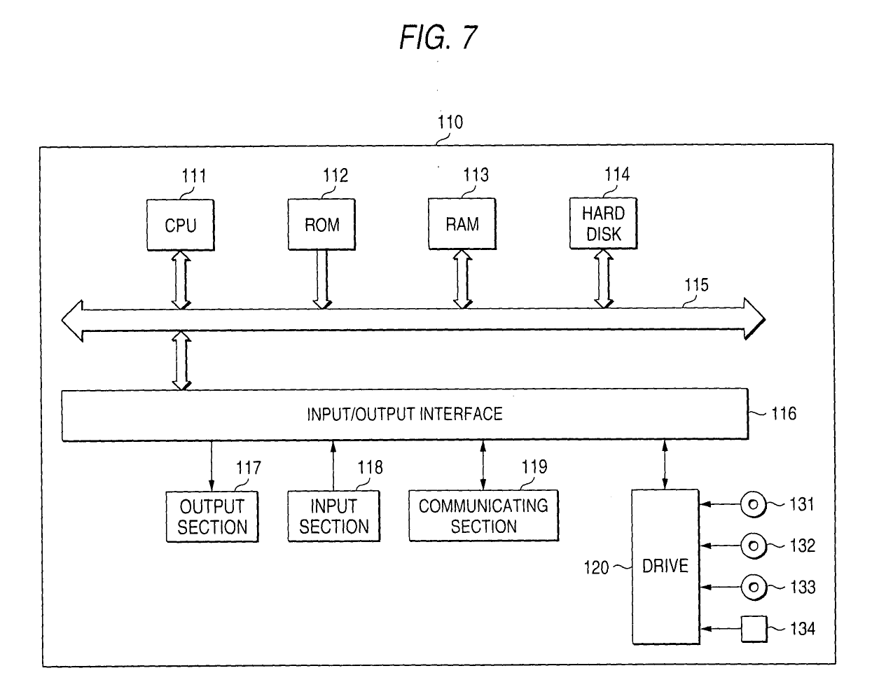

FIG. 7 is a block diagram showing a configuration of an embodiment of a computer 101 to function as a receiving section as described in the above. A CPU (Central Processing Unit) 111 is connected with an input/output interface 116 through a bus 115. When an instruction is inputted at an input section 118 made by a keyboard, mouse or the like from the user through the input/output interface 116, the CPU 111 loads onto a RAM (Random Access Memory) 113 a program stored, for example, on a ROM (Read Only Memory) 112, a hard disk 114 or a storage medium, such as a magnetic disk 131, optical disk 132 or a magnetooptical disk 133 or semiconductor memory 134, inserted in the drive 120, to execute it. Due to this, the foregoing various processes are to be effected. Furthermore, the CPU 111 outputs, as required, a result of the processing onto a display section 117 configured by an LCD (Liquid Crystal Display) or the like, for example, through an input/output interface 116. Incidentally, the program can be previously stored on the hard disk 114 or ROM 112 and provided integrally with a computer 101 to the user. Otherwise, it can be provided as a packaged media, such as of a magnetic disk 131, an optical disk 132, a magneto-optical disk 133 or a semiconductor memory 134, or provided onto the hard disk 114 from a satellite, network or the like via a communicating section 119.

### INDUSTRIAL APPLICABILITY

As described in the above, according to the receiver of the invention, a receiver can be configured without the utilization of a SAW filter, for example. The invention is to be applied to a television receiver, for example.

1. A receiver comprising:
first generating means for multiplying an analog television broadcast signal by a first reference signal to generate a first signal to be detected;
second generating means for multiplying the analog television broadcast signal by a second reference signal orthogonal to the first reference signal to generate a second signal to be detected; and
detecting means for detecting a base band signal, on the basis of the first signal to be detected and the second signal to be detected.

2. A receiver according to claim 1, further comprising third generating means to generate an intermediate frequency signal from the analog television broadcast signal,
the first generating means multiplying the intermediate frequency signal by the first reference signal to generate the first signal to be detected,
the second generating means multiplying the intermediate frequency signal by the second reference signal to generate the second signal to be detected.

3. A receiver according to claim 2, further comprising removing means to remove an unwanted high-frequency component contained in the intermediate frequency signal,
the first generating means multiplying the first reference signal on the intermediate frequency signal removed of an unwanted high-frequency component by the removing means to generate the first signal to be detected,
the second generating means multiplying the second reference signal on the intermediate frequency signal removed of an unwanted high-frequency component by the removing means to generate the second signal to be detected.

4. A method of receiving a signal comprising:
a first generating step of multiplying an analog television broadcast signal by a first reference signal to generate a first signal to be detected;
a second generating step of multiplying the analog television broadcast signal by a second reference signal orthogonal to the first reference signal to generate a second signal to be detected; and
a detecting step of detecting a base band signal, on the basis of the first signal to be detected and the second signal to be detected.

5. A recording medium recording a program to be read by a computer, comprising:
a first generating step of multiplying an analog television broadcast signal by a first reference signal to generate a first signal to be detected; a second generating step of multiplying the analog television broadcast signal by a second reference signal orthogonal to the first reference signal to generate a second signal to be detected; and
a detecting step of detecting a base band signal, on the basis of the first signal to be detected and the second signal to be detected.

6. A program for a computer to execute a process comprising:
a first generating step of multiplying an analog television broadcast signal by a first reference signal to generate a first signal to be detected;
a second generating step of multiplying the analog television broadcast signal by a second reference signal orthogonal to the first reference signal to generate a second signal to be detected; and
a detecting step of detecting a base band signal, on the basis of the first signal to be detected and the second signal to be detected.
